(19) United States
(12) Patent Application Publication
(10) Pub. No.: US 2025/0246726 A1
(43) Pub. Date: Jul. 31, 2025

(54) BATTERY CELL ENCLOSURE INCLUDING STEEL BODY WITH THERMALLY CONDUCTIVE LAYER TO IMPROVE THERMAL AND SEALING PERFORMANCE

(71) Applicant: GM GLOBAL TECHNOLOGY OPERATIONS LLC, Detroit, MI (US)

(72) Inventors: Diptak Bhattacharya, Royal Oak, MI (US); Anil K. Sachdev, Rochester Hills, MI (US); Xiaoling Chen, Sterling Heights, MI (US); Derek Frei Lahr, Ann Arbor, MI (US); Andrew Clay Bobel, Troy, MI (US); Ryan Patrick Hickey, Austin, TX (US); Junjie Ma, Novi, MI (US); Vamakshi Yadav, Sterling Heights, MI (US)

(21) Appl. No.: 18/425,511

(22) Filed: Jan. 29, 2024

(51) Int. Cl. H01M 50/128; C23C 2/34; C25D 3/38; H01M 50/103; H01M 50/119; H01M 50/133

(52) U.S. Cl. CPC H01M 50/128; C23C 2/34; C25D 3/38; H01M 50/103; H01M 50/119; H01M 50/133; H01M 2220/20

(57) ABSTRACT

An enclosure for a prismatic battery cell includes an enclosure body including sides, a lid portion, and a bottom portion. The enclosure body is made of steel. A layer is arranged on the enclosure body and includes a material having a higher thermal conductivity than the steel. The layer includes a coating layer or a clad layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cell enclosures including a steel body including a thermally conductive coating layer or clad layer.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include one or more cathode electrodes, anode electrodes, and separators arranged in a battery cell enclosure. The cathode electrodes include a cathode active material layer arranged on a cathode current collector. The anode electrodes include an anode active material layer arranged on an anode current collector.

### SUMMARY

An enclosure for a prismatic battery cell includes an enclosure body including sides, a lid portion, and a bottom portion. The enclosure body is made of steel. A layer is arranged on the enclosure body and includes a material having a higher thermal conductivity than the steel.

In other features, the layer includes a metallic coating. The metallic coating is selected from a group consisting of copper, copper-zinc, zinc, and an aluminum alloy. The aluminum alloy is selected from a group consisting of Al-6% Si and Al-55% Zn. The metallic coating is applied using electroplating. The metallic coating is applied using hot dipping.

In other features, a nickel coating is arranged on the steel. The metallic coating is applied on the nickel coating and the metallic coating is selected from a group consisting of copper, copper-zinc, and zinc.

In other features, the layer includes a clad layer attached by adhesive to the enclosure body. The clad layer includes copper.

In other features, the layer includes a ceramic coating selected from a group consisting of aluminum nitride, boron nitride, and aluminum oxide. A thickness of the steel is in a range from 0.2 mm to 0.8 mm. A thickness of the metallic coating is in a range from 5 μm to 100 μm.

A system comprising the enclosure and a thermal interface material in contact with at least one of the lid portion and the bottom portion of the enclosure. A cooling plate is in thermal contact with the thermal interface material.

A method for manufacturing a prismatic enclosure of a battery cell includes forming an enclosure body of the prismatic enclosure using steel. The enclosure body includes one of a coated layer on the enclosure body; and a clad layer attached to the enclosure body. The one of the coating layer and the clad layer is made of a material having a higher thermal conductivity In other features, the enclosure body includes the coating layer. The coating layer includes a metallic coating selected from a group consisting of copper, copper-zinc, zinc, and an aluminum alloy.

In other features, the method includes applying the metallic coating using one of electroplating and hot dipping.

In other features, the enclosure body includes the clad layer, and the clad layer includes a metallic material attached by adhesive to the enclosure body.

In other features, the enclosure body includes the coating layer, and the coating layer includes a ceramic coating selected from a group consisting of aluminum nitride, boron nitride, and aluminum oxide.

In other features, a thickness of the steel is in a range from 0.2 mm to 0.8 mm, and a thickness of the metallic coating is in a range from 5 μm to 100 μm.

In other features, forming the enclosure body includes at least one of deep drawing; bending and welding; and roll forming, welding, and expanding.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a battery cell including a battery cell stack with anode electrodes, cathode electrodes, and separators arranged in steel enclosure with a thermally conductive layer according to the present disclosure;

FIGS. 2A and 2B are perspective views of examples of prismatic battery cell enclosures made of steel with a thermally conductive layer according to the present disclosure; and

FIG. 3 is a side cross section illustrating an example of heat transfer in a prismatic battery cell without a thermally conductive layer including an enclosure made of steel;

FIG. 4 is a side cross section illustrating an example of heat transfer in a prismatic battery cell including an enclosure with a steel body including a thermally conductive clad layer according to the present disclosure;

FIGS. 5A and 5B are side cross sections illustrating an example of heat transfer in a prismatic battery cell including an enclosure with a steel body including a thermally conductive coating layer according to the present disclosure;

FIG. 6 is a perspective view illustrating an example of a roll of steel sheet including a thermally conductive coating layer according to the present disclosure;

FIG. 7 is a perspective view illustrating manufacturing of a steel sheet with a thermally conductive clad layer according to the present disclosure;

FIG. 8 are plan and perspective views illustrating an example of roll forming, welding, and expanding the steel sheet including the thermally conductive layer to form the enclosure according to the present disclosure;

FIG. 9 are plan and perspective views illustrating an example of bending and welding the steel sheet including the thermally conductive layer to form the enclosure according to the present disclosure;

FIG. 10 are plan and perspective views illustrating an example of forming the enclosure using deep drawing of the steel sheet including the thermally conductive layer according to the present disclosure;

FIG. 11 is a side cross section illustrating an example of welding of a lid to a body of the enclosure according to the present disclosure;

FIG. 12 is a side cross section illustrating an example of brazing of a lid to a body of the enclosure according to the present disclosure; and

FIGS. 13A to 13C are side cross sections illustrating an example of double seaming of the steel sheet including the thermally conductive layer according to the present disclosure.

In the drawings, reference numbers may be reused to identify similar and/or identical elements.

### DETAILED DESCRIPTION

While battery enclosures according to the present disclosure are shown in the context of electric vehicles, the battery enclosures can be used in stationary applications and/or other applications.

Prismatic enclosures are typically made by extruding aluminum which is an expensive material. Aluminum also poses limitations when used with high energy battery cells that have a potential for thermal runaway. Thermal runaway may lead to sustained high temperatures that can melt the battery cell enclosure.

During thermal runway, hot gases are released within the battery cell. The hot gases have temperatures exceeding 800° C. to 900° C., which are high enough to melt the aluminum battery enclosure (melting temperature of 600° C. to 630° C.). Even at lower temperatures (above 300° C.), the aluminum softens which reduces the strength of the aluminum battery enclosure (e.g., the tensile strength of Al at 300° C. is about 25% to 35% of the room temperature tensile strength). Melting of the enclosure may lead to ejection of highly oxidizing aluminum shards and particles that exacerbate the thermal runaway event.

Steel may be used for the battery cell enclosures instead of aluminum. Steel has a lower cost than aluminum and a much higher melting point (1500° C.). The higher melting temperature of steel allows the battery cell enclosure to resist melting during thermal runaway. However, the disadvantage with steel is that, steel teel has lower thermal conductivity as compared to aluminum. Lower thermal conductivity of steel increases the battery cell temperature during fast charge/discharge events.

The present disclosure relates systems and methods for improving the cooling efficiency of prismatic battery cell enclosures that include an enclosure body made of steel when the stack of prismatic cells are bottom cooled by placing the bottom over liquid cold plates. (rather than direct cooling of faces of the cell). In some examples, outer surfaces of the battery cell enclosures are coated with a thermally conductive coating layer or a clad layer made of a material having a higher thermal conductivity than the steel body. In some examples, the coating layer includes a metallic layer that is electroplated or dip coated. In some examples, the coating layer includes a ceramic layer. The thermally conductive layer reduces the cell temperature during fast charging by providing a conductive pathway wherein the heat of the battery cell is withdrawn through the coating layer to the cooling plate.

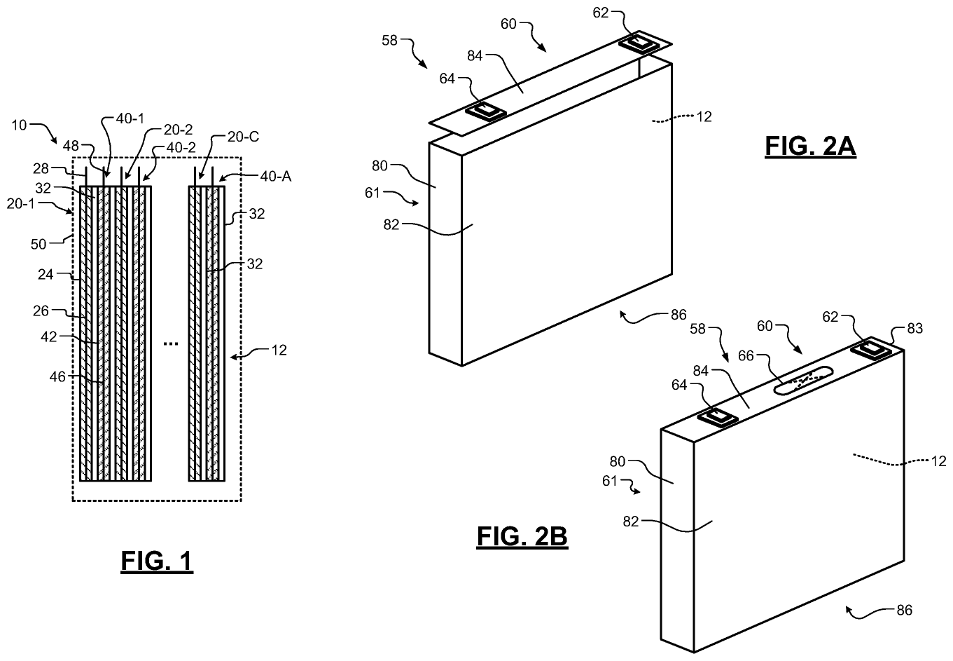

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The C cathode electrodes 20-1, 20-2, . . . , and 20-C include cathode active material layers 24 arranged on one or both sides of a cathode current collector 26.

The A anode electrodes 40-1, 40-2, . . . , and 40-A include anode active material layers 42 arranged on one or both sides of the anode current collectors 46. In some examples, the A anode electrodes 40 and the C cathode electrodes 20 exchange lithium ions during charging/discharging. In some examples, the cathode active material layers 24 and/or the anode active material layers 42 comprise coatings including one or more active materials, one or more conductive additives, and/or one or more binder materials that are applied to the current collectors (e.g., using a wet or dry roll-to-roll process).

In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIGS. 2A and 2B, a battery cell 58 includes an enclosure 60. In some examples, the enclosure 60 has a prismatic shape with rectangular cross-sections in x-, y- and z-axis planes. In some examples, the enclosure 60 includes an enclosure body 61 including sides 80 corresponding to narrow faces and sides 82 corresponding to wide faces. The enclosure body 61 defines an open- or closed-ended rectangular prism. In some examples, the enclosure 60 includes a lid portion 84 and a bottom portion 86. In other examples, the bottom portion 86 is attached after the enclosure body 61 is formed. Edges 83 are arranged between the sides 80 and 82, the sides 80 and 82 and a lid portion 84, the sides 80 and 82 and the bottom portion 86.

The lid portion 84 and optionally the bottom portion 86 are attached to the enclosure body 61 to enclose top and the bottom openings of the enclosure body 61, respectively. The battery cell 58 includes external terminals 62 and 64 that pass through the lid portion 84. The battery cell stack 12 of the C cathode electrodes 20, the A anode electrodes 40, and the S separators 32 is arranged in the enclosure 60.

The external terminals 62 and 64 are connected to external tabs 28 and 48 of the C cathode electrodes 20 and the A anode electrodes 40, respectively. In FIG. 2A, the lid portion 84 does not include a pressure-based vent cap. In FIG. 2B, the lid portion 84 (and/or the bottom portion 86) includes a pressure-based vent cap 66. The pressure-based vent cap 66 is configured to release vent gases when pressure within the inner enclosure is greater than a predetermined pressure.

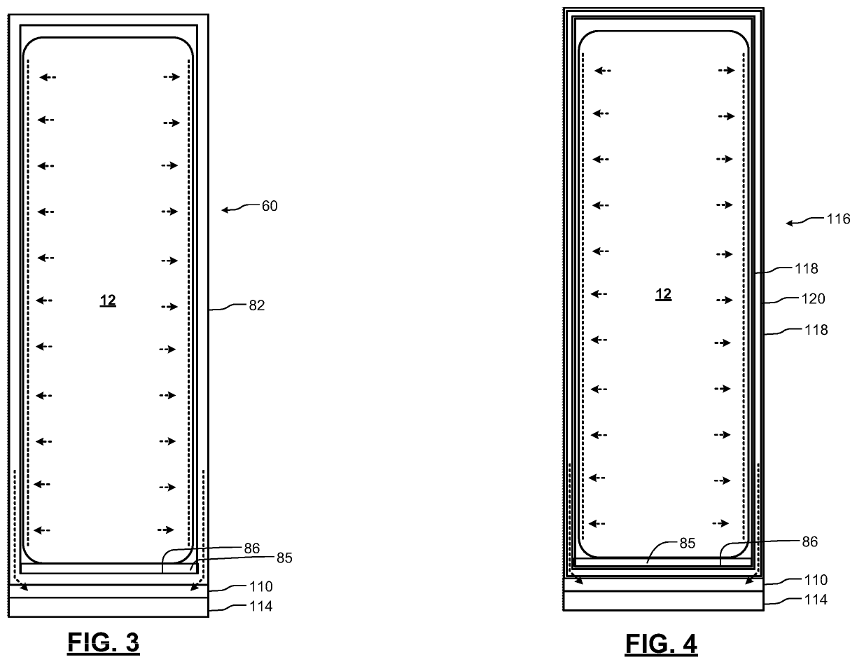

Referring now to FIG. 3, heat transfer in a prismatic battery cell is shown. A bottom surface of the battery cell sits on a thermal interface material (TIM) 110. The TIM 110 sits on a cold plate 114. Heat from the battery cell stack 12 flows predominantly outwardly as shown by arrows. When battery cells are cooled by a cold plate 114 arranged adjacent to the lid or bottom portion (rather than direct side wall cooling), the primary heat transfer path is through the sides 82 of the enclosure 60 down towards the cold plate 114 via a thermal interface material (TIM) 110. Steel (with lower thermal conductivity compared to aluminum) reduces the flux of heat transfer through the sides 82 of the enclosure 60 into the cold plate 114. In some examples, an electrolyte layer 85 is arranged between the battery cell stack 12 and the bottom portion 83. In some examples, the electrolyte layer 85 is made of a thermally non-conductive material. Due to the electrolyte layer 85, the primary heat transfer path is through the sides 80 and 82.

Referring now to FIG. 4, heat transfer in a prismatic battery cell including inner and/or outer clad layers 118 adjacent to a steel wall 120 is shown. The inner and/or outer clad layers 118 include metallic sheets having higher thermal conductivity than material used for the enclosure. Heat from the battery cell stack 12 flows predominantly outwardly as shown by arrows. Heat flows through the steel walls 120 and the inner and/or outer clad layers 118 of the enclosure 116 down towards the cold plate 114 via the thermal interface material (TIM) 110. In some examples, both the inner and/or outer clad layers 118 are used. In other examples, only the inner clad layer or only the outer clad layer is used. In some examples, the inner and/or outer clad layers 118 are made of copper or a copper alloy, although other materials can be used.

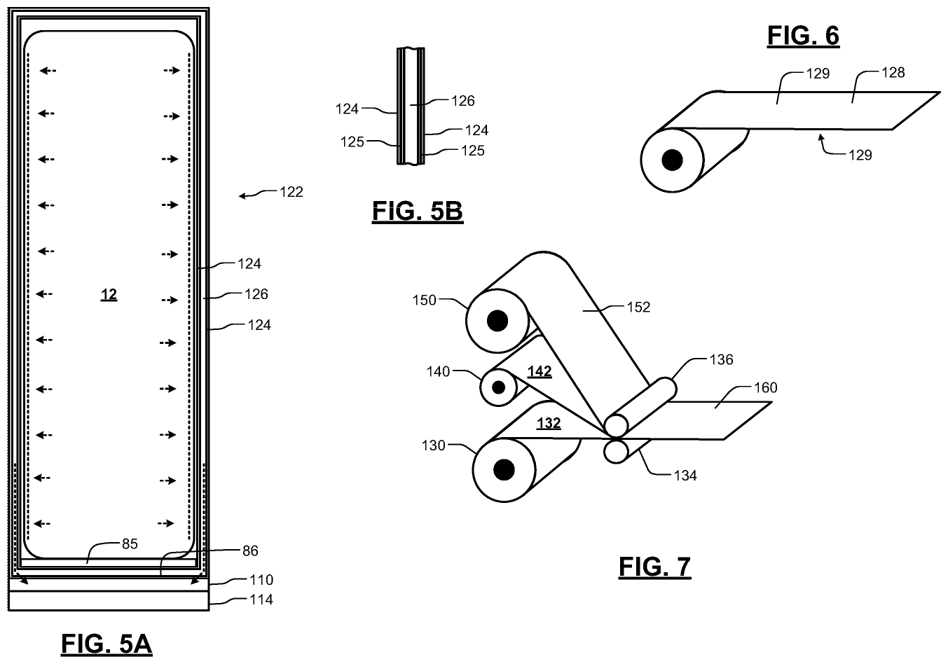

Referring now to FIGS. 5A and 5B, heat transfer in a prismatic battery cell including inner and outer coating layers 124 adjacent to a steel wall 122 is shown. Heat from the battery cell stack 12 flows predominantly outwardly as shown by arrows. Heat flows through the steel walls 122 and the inner and outer coating layers 124 of the enclosure towards the cold plate 114 via the thermal interface material (TIM) 110. The inner and outer coating layers 124 provide a high thermal conductivity pathway for heat transfer to the cold plate 114.

In some examples, the inner and outer coating layers 124 include a metallic coating that is both electrically and thermally conductive. Examples of metallic coatings include pure copper having a thermal conductivity of 400 W/m·K, a copper-zinc (Cu—Zn) coating (e.g., brass) having a thermal conductivity of 150 W/m·K, pure zinc having a thermal conductivity of 112 W/m·K, or an aluminum alloy. Examples of aluminum alloys include Al-6% Si (having a thermal conductivity of 155 W/m·K) or Al-55% zinc (having a thermal conductivity of 122 W/m·K). In some examples, the metallic coating is applied using electroplating or hot dipping.

In FIG. 5B, a thin electroplated nickel layer 125 can be applied prior to the coating layer 126 including pure Cu, Cu—Zn, or Zn to improve weldability by avoiding liquid copper embrittlement of steel grain boundaries.

For example, the steel walls 122 can be coated with a copper coating using electroplating. Steel has a thermal conductivity of 45 W/m·K and copper has a thermal conductivity of 400 W/m·K. The TIM 110 has a thermal conductivity of 1-2 W/m·K and the cold plate has a thermal conductivity of 273 W/m·K. For example, battery cell temperatures during 2 C charging can be about 41° C. for a steel enclosure without cladding or coatings and 35.5° C. for an aluminum enclosure. The battery cell temperatures in the enclosure during 2 C charging with 20 μm, 30 μm, 40 μm, and 50 μm copper coatings decreases to 38.5° C., 37.5° C., 36.9° C. and 36.1° C., respectively.

In other examples, the inner and outer coating layers 124 include a ceramic coating that is thermally conductive and electrically insulating. In some examples, the ceramic coating is selected from a group consisting of aluminum nitride (AlN), boron nitride (BN), and aluminum oxide or alumina (Al₂O₃). Aluminum nitride (AlN) has a thermal conductivity of 220 W/m·K. Boron nitride (BN) has a thermal conductivity of 70 W/m·K. Aluminum oxide or alumina (Al₂O₃) has a thermal conductivity of 112 W/m·K.

In some examples, the ceramic coating is applied to the enclosure using spray drying using a siphon feed hookup. The particles of the ceramic coating (e.g., AlN) are dispersed in a solvent (e.g., ethanol) and air drying evaporates the ethanol from the ceramic coating.

Referring now to FIGS. 6 and 7, a steel sheet coated with a metallic or ceramic coating or a clad steel sheet, respectively, can be used. In FIG. 6, a steel sheet 128 includes a coating layer 129 on inner and/or outer surfaces thereof. In some examples, the coating layer 129 such as the metallic coating or ceramic coating. While the coating layers are shown on the steel sheet prior to rolling, bending or drawing, the coating can be applied after. In some examples, the coating layer 129 is applied on mild steel or stainless steel via electroplating or hot dip coating, although other methods can be used.

In some examples, the thickness of the steel is in a range from 0.2 mm to 0.8 mm. In some examples, the thickness of the steel is in a range from 0.3 mm to 0.4 mm. In some examples, the thickness of the coating layer 129 is in a range from 5 μm to 100 μm. In some examples, the thickness of the coating layer 129 is in a range from 10 μm to 50 μm. In some examples, the coating layer 129 is deposited on both sides of the steel enclosure body.

In FIG. 7, a roll 130 includes steel sheet 132 that is supplied between rollers 134 and 136. A roll 140 including an adhesive layer 142 is supplied between the rollers 134 and 136. A roll 150 includes a cladding layer 152 made of a metallic material that is supplied between the rollers 134 and 136. The rollers 134 and 136 press and/or heat the layers to form a clad sheet 160. The process can be repeated for the clad layer on the opposite side or additional rolls including the adhesive layer and the clad layer can be supplied between the rollers 134 and 136 double side cladding is performed. In some examples, the adhesive includes thermally conductive adhesive. While the clad layers are shown on the steel sheet prior to rolling, bending, or drawing, the clad layers can be applied before and/or after.

Referring now to FIGS. 8 to 10, examples of forming an enclosure body for a three-piece enclosure using steel sheet with a coating layer or clad steel sheet is shown. In FIG. 8, roll forming, welding, and/or expanding are used to form the enclosure body. A coated or clad steel sheet 210 is cut to size and includes edges 214 that are to be welded. The steel sheet 212 is roll formed into a cylinder 218 and welded (e.g., using resistance, laser, induction, or friction stir welding) along a seam at the edges 214. The steel sheet 212 is expanded into an enclosure body at 218′.

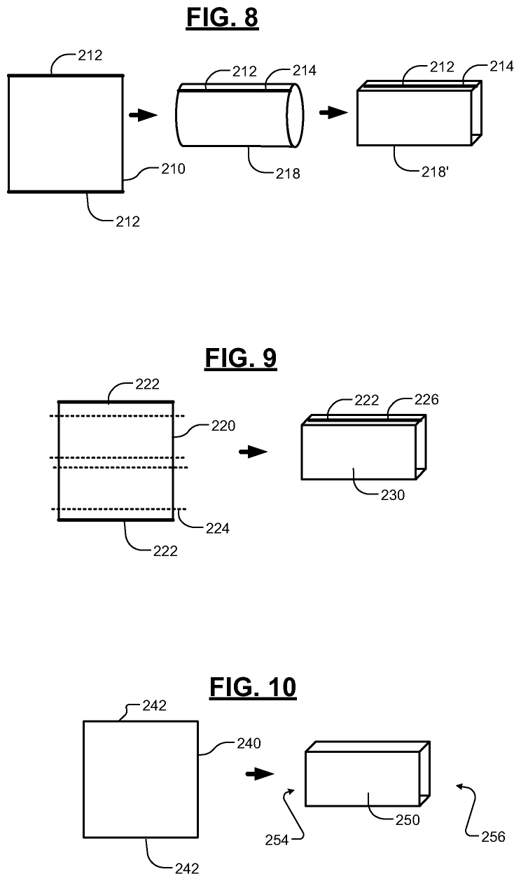

In FIG. 9, bending and welding are used to form the enclosure. A coated or clad steel sheet 222 is cut and bent along dotted lines at 224 to form an enclosure body 230. After bending, edges are seam welded at 226 along one side (e.g., a narrow side).

In FIG. 10, an enclosure body 250 for a two-piece enclosure is formed using deep drawing. The enclosure body 250 is formed by deep drawing steel 240. The enclosure body 260 includes an integrated bottom portion 254 on one side and an opening 256 on the opposite side that is enclosed by a lid portion. In some examples, the enclosure body 250 is coated or clad before and/or after deep drawing.

Referring now to FIGS. 11 to 12, a lid 310 includes a steel sheet 314 with inner and/or outer layers 316 (e.g., a clad or coating layer). An enclosure body 330 includes steel sheet 314 with outer layers 336 (e.g., a clad or coating layer). For thinner layers/coatings, an edge of the lid 310 is heated (induction or laser) to a side wall of the enclosure body 330. The heat forms a junction between the lid 310 and the side wall of the enclosure body 330. For thicker layers/coatings, laser brazing can be performed using a filler wire (e.g., copper-silicon alloy). Brazing is used to weld the side wall of the lid to a top of the enclosure body. Brazing avoids melting of the steel and overheating of electrodes of the battery cell stack.

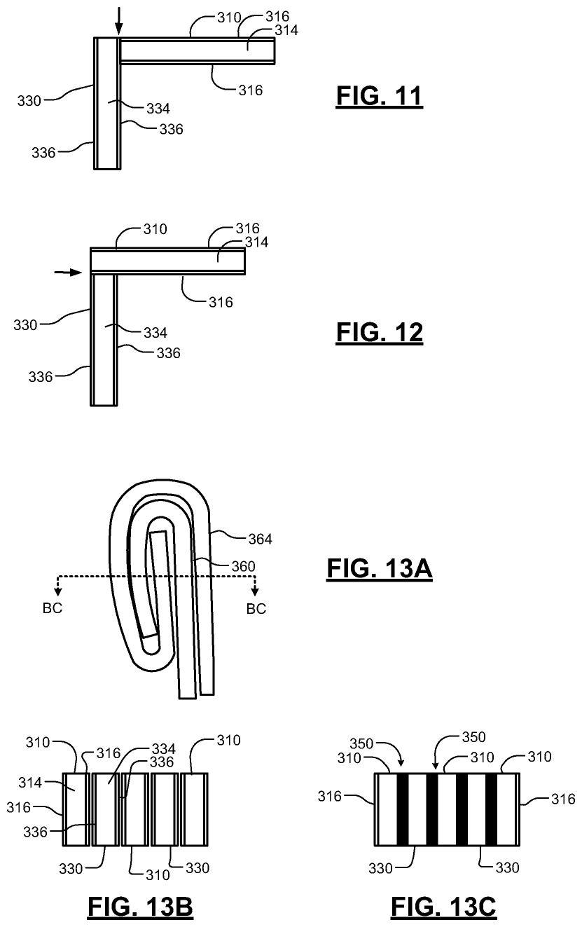

Referring now to FIGS. 13A to 13C are side cross sections illustrating an example of crimping of a double seam to join the lid or bottom portion to the enclosure body. In FIGS. 13A and 13B, an enclosure body 360 and a lid 364 are crimped using a double seam.

Brazing can be used to strengthen the crimp. Brazing involves moving a heat source around the periphery of the crimp to melt and bond the coatings from adjacent steel layers. In some examples, one or more laser beams are directed onto the double seam after crimping to melt coating layers together as shown at 350 in FIG. 13C. Facing layers of the coating layer or the clad layer melt and fuse together between the outer different layers to improve the quality of the hermetic seal. While laser heating is shown, in other examples, induction heating can be used.

The thermally conductive layers on the inner and/or outer surfaces of the steel enclosure bodies enhance thermal conductivity of the battery cells during charging/discharging to control the temperature of the battery cell. The clad/coating layers provide thermally conductive pathways for effective heat transfer to the cold plate in edge cooling situations.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. An enclosure for a prismatic battery cell, comprising:
an enclosure body including sides, a lid portion, and a bottom portion,
wherein the enclosure body is made of steel; and
a layer arranged on the enclosure body and including a material having a higher thermal conductivity than the steel.

2. The enclosure of claim 1, wherein the layer includes a metallic or metallic alloy coating.

3. The enclosure of claim 2, wherein the metallic coating is selected from a group consisting of copper, copper-zinc (Cu—Zn), zinc, and an aluminum alloy.

4. The enclosure of claim 3, wherein the aluminum alloy is selected from a group consisting of Al-6% Si and Al-55% Zn.

5. The enclosure of claim 3, wherein the metallic coating is applied using electroplating.

6. The enclosure of claim 3, wherein the metallic coating is applied using hot dipping.

7. The enclosure of claim 3, further comprising a nickel coating on the steel, wherein the metallic coating is applied on the nickel coating and the metallic coating is selected from a group consisting of copper, copper-zinc (Cu—Zn), and zinc.

8. The enclosure of claim 1, wherein the layer includes a clad layer attached by adhesive to the enclosure body.

9. The enclosure of claim 8, wherein the clad layer includes copper.

10. The enclosure of claim 1, wherein the layer includes a ceramic coating selected from a group consisting of aluminum nitride (AlN), boron nitride (BN), and aluminum oxide (Al₂O₃).

11. The enclosure of claim 1, wherein a thickness of the steel is in a range from 0.2 mm to 0.8 mm.

12. The enclosure of claim 2, wherein a thickness of the metallic coating is in a range from 5 μm to 100 μm.

13. A system comprising the enclosure of claim 1 and further comprising:
a thermal interface material in contact with at least one of the lid portion and the bottom portion of the enclosure; and
a cooling plate in thermal contact with the thermal interface material.

14. A method for manufacturing a prismatic enclosure of a battery cell, comprising:
forming an enclosure body of the prismatic enclosure using steel; and
wherein the enclosure body includes one of
a coated layer on the enclosure body; and
a clad layer attached to the enclosure body,
wherein the one of the coating layer and the clad layer is made of a material having a higher thermal conductivity than the steel.

15. The method of claim 14, wherein:
the enclosure body includes the coating layer, and
the coating layer includes a metallic coating selected from a group consisting of copper, copper-zinc (Cu—Zn), zinc, and an aluminum alloy.

16. The method of claim 15, further comprising applying the metallic coating using one of electroplating and hot dipping.

17. The method of claim 14, wherein:
the enclosure body includes the clad layer, and
the clad layer includes a metallic material attached by adhesive to the enclosure body.

18. The method of claim 14, wherein:
the enclosure body includes the coating layer, and
the coating layer includes a ceramic coating selected from a group consisting of aluminum nitride (AlN), boron nitride (BN), and aluminum oxide (Al₂O₃).

19. The method of claim 15, wherein:
a thickness of the steel is in a range from 0.2 mm to 0.8 mm, and
a thickness of the metallic coating is in a range from 5 μm to 100 μm.

20. The method of claim 14, wherein forming the enclosure body includes at least one of:
deep drawing;
bending and welding; and
roll forming, welding, and expanding.
